(19) United States
(12) Patent Application Publication
(10) Pub. No.: US 2015/0211916 A1
(43) Pub. Date: Jul. 30, 2015

(54) WARNING DEVICE AND METHOD FOR MONITORING ALARM STATUS OF A VIBRATION LEVEL OF A PIECE OF ROTATING MACHINERY HAVING AN ADAPTIVE ALARM INDICATOR

(71) Applicants: Mark McGinn, Escondido, PA (US); Jonathan David Murphy, Friday Harbor, WA (US)

(72) Inventors: Mark McGinn, Escondido, PA (US); Jonathan David Murphy, Friday Harbor, WA (US)

(21) Appl. No.: 14/408,641

(22) PCT Filed: Jun. 20, 2013
(86) PCT No.: PCT/US13/46828

§ 371 Date: Dec. 17, 2014

Related U.S. Application Data
(60) Provisional application No. 61/663,070, filed on Jun. 22, 2012.

(51) Int. Cl. G01H 1/00; G08B 21/18

(52) U.S. Cl. CPC G01H 1/003; G08B 21/18

(57) ABSTRACT

A warning device apparatus for monitoring an alarm status of a bearing that is mounted to a piece of rotating machinery is provided. The warning device includes a body portion, a top portion, a base portion, a power source for powering the device throughout a life of operation, a controller for controlling the operation of the warning device and at least one LED for displaying the alarm status. An operator inspects the warning device for an initial alarm indication by visually inspecting the at least one LED. The at least one LED is controlled to blink at a relatively quick initial rate and/or intensity that maximizes indicator visibility to the operator at initial indication. The at least one LED is controlled to blink at a slower/decreasing rate as time passes. Battery life of operation is extended by virtue of the slower/increased blink rate and conversely the increased pause time.

### FIELD OF THE INVENTION

The present disclosure generally relates to a device for monitoring alarm status of a vibration level of a piece of rotating having an adaptive alarm indicator. More particularly, the present disclosure relates to a warning device having an adaptive alarm indicator that blinks less frequently as time passes since a first alarm indication event.

### BACKGROUND OF THE INVENTION

The present invention provides a simple, low cost way to monitor and indicate the status of a bearings health in a piece of rotating industrial equipment. Historically simple transmitter based systems have been employed on industrial machinery for overall machine health and detection of bearing degradation. These devices measure continuously and can be connected to existing control systems (PLC or DCS). The simplest approach is a 420VT Vibration Transmitter. This loop-powered device measures Velocity (and can include Temperature) and has an End-User cost of about $ 400.00. Also, a major consideration is the installation cost, especially for cabling.

Most machine condition indicators (MCI's) found in industrial environments are line powered and can afford to consume a significant amount of power while indicating an alarm status. However, it is expensive to wire all indicators to line power and line power is not always easy to access. For this reason a battery powered indicator of the present invention is desirable. However, battery power indicators must balance visibility and information content against battery life. The present invention provides a low cost battery powered device that accomplishes these desired goals.

### SUMMARY OF THE INVENTION

The basic inventive concept provides a warning device for monitoring alarm status of a vibration level of a piece of rotating having an adaptive alarm indicator.

A first aspect of the present invention provides a warning device for monitoring alarm status of a vibration level a piece of rotating machinery, the warning device comprising:

a body portion;

a top portion;

a base portion;

a power source for powering the device throughout a life of operation;

a control unit for controlling the operation of the warning device;

at least one colored light indicator for displaying the alarm status of the monitored vibration level; and wherein

the at least one colored light indicator being energized to blink after an initial alarm indication; and wherein

the at least one colored light indicator being controlled to blink at a relatively quick initial rate and/or intensity that maximizes indicator visibility; and wherein

the at least one colored light indicator being controlled to blink at a relatively slower decreasing rate as time passes from the initial indication event; and wherein

power source life of operation is extended by virtue of the relatively decreasing blink rate from initial alarm indication over time.

In a second aspect of the present invention the power source is a lithium battery rated for long life.

In a third aspect of the present invention the lithium battery is sealed in epoxy and is not replaceable.

In another aspect of the present invention the power source life of operation decreases proportionally with the number of alarm detections.

In another aspect of the present invention the power source supports operation of the warning device for three years of life after one alarm detection.

In another aspect of the present invention the power source supports operation of the warning device for two years of life after two alarm detections.

In another aspect of the present invention the power source supports operation of the warning device for one year of life after three alarm detections.

In another aspect of the present invention the warning device is manually reset after an alarm condition is detected.

In another aspect of the present invention the warning device can be reset up to three times before replacement is required.

In another aspect of the present invention the at least one colored light indicator further comprises a tri-color LED.

In another aspect of the present invention the control unit further comprises a circuit board that works in conjunction with at least one sensor to monitor vibration.

In another aspect of the present invention the vibration level of a bearing is being monitored.

In another aspect of the present invention the vibration level of a gearbox is being monitored.

In a final aspect of the present invention a method of indicating an alarm status of a warning device that monitors a life of a bearing, the bearing and warning device disposed proximate to each other on a piece of rotating industrial machinery, the method of indicating the alarm status comprising the steps of:

providing the warning device having;
a control unit,
at least one colored light indicator, and
a power source; and

controlling the operation of the warning device with the control unit,

displaying the alarm status with the at least one light indicator,

powering the device throughout a life of operation with the power source;

indicating an initial alarm indication with the at least one colored light indicator, and

controlling the at least one colored light indicator with the control unit to blink at a relatively quick initial rate and/or intensity that maximizes indicator visibility at initial indication;

controlling the at least one colored light indicator with the control unit to blink at a relatively slower decreasing rate as time passes from the initial indication; and wherein

extending power source life of operation by virtue of the relatively decreasing blink rate from initial indication over time is achieved.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 is an elevated perspective view of a warning device according to a preferred embodiment of the present invention;

FIG. 2 is a bottom side view of the warning device of FIG. 1, according to a preferred embodiment of the present invention;

FIG. 3 is a perspective view of the warning device of FIG. 1 with the body removed, according to a preferred embodiment of the present invention

FIG. 4 is a partial cross-sectional view in perspective of the warning device of FIG. 1 with the body removed, according to a preferred embodiment of the present invention;

FIG. 5 is a partial view of an inner bearing raceway having 3^{rd} order defects; and

FIG. 6 is a perspective view of an industrial environment showing multiple pieces of machinery configured with the warning device of FIG. 1 according to a preferred embodiment of the present invention.

FIG. 7 is a perspective view of an industrial environment showing an operator inspecting the light emitting diodes of the warning device of FIG. 1 according to a preferred embodiment of the present invention.

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

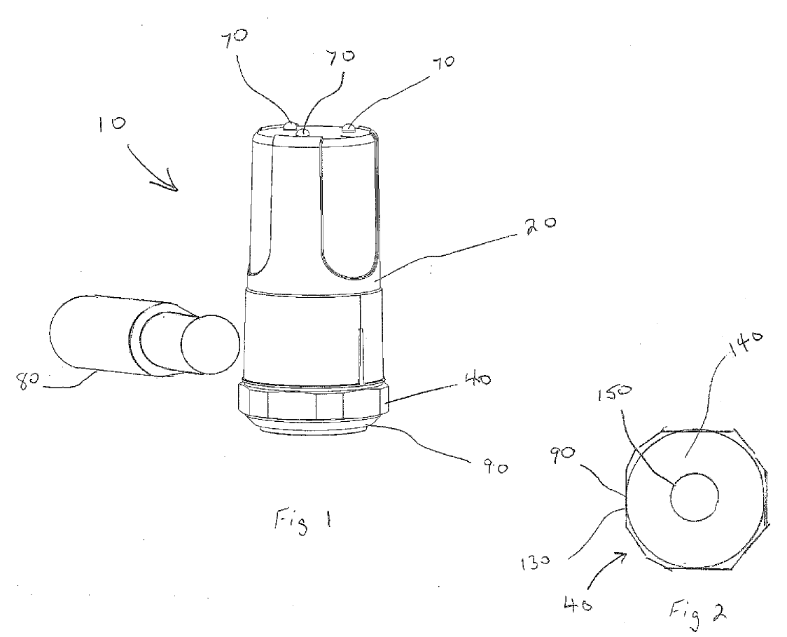

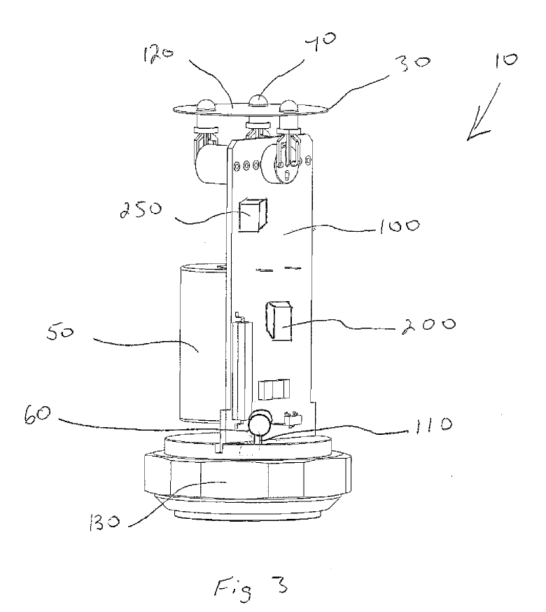

For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

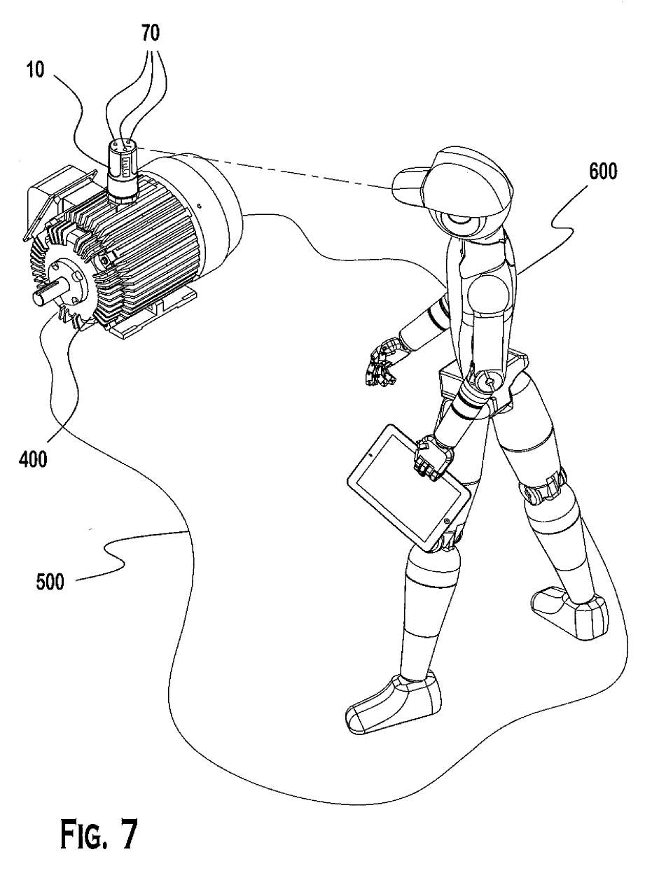

A warning device 10 for monitoring a health status of a bearing is illustrated in FIG. 1. The warning device is typically mounted to a piece of rotating industrial machinery 400 that is disposed in a manufacturing or operating environment 500. See FIG. 6 illustrating the warning device mounted to the machinery in the industrial environment. Typical applications for the warning device of the present invention include motors, fans, conveyors and pumps.

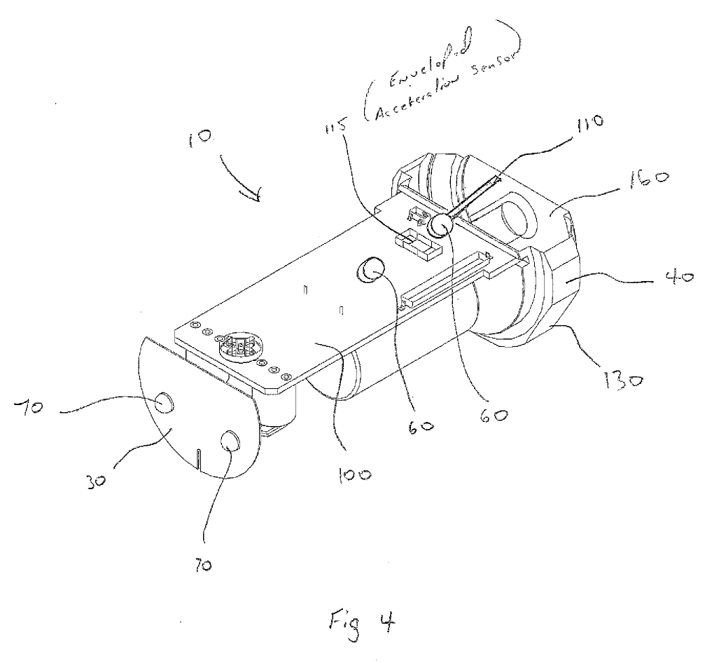

Referring back to FIG. 1, the warning device provides a generally cylindrical body portion 20 that is connected to an annular top portion 30. The annular top portion 30 includes at least one colored light indicator 70 for displaying the health status of the bearing. The at least one colored light indicator is mounted on an upper top surface 120 of the annular top portion 30 of the warning device for maximum visibility to a user. Referring to FIG. 3, the at least one colored light indicator may further provide at least one translucent light emitting diode (70).

Depending on the voltage applied to the at least one translucent LED 70, the LED may be configured to illuminate any one of red, green or translucent. Normally, the at least one translucent LED functions to illuminate red or green. However, the LED used in the present invention is configured to illuminate translucent as well. In this case, the LED is energized to illuminate both red and green. The net affect of illuminating both red and green simultaneously, creates an amber illumination. The need for providing the three different colors will be disclosed in ensuing paragraphs. Here, the at least one LED 70 may provide three LED's 70 assembled in parallel on an upper top surface (120) of the device. The three LED's may be configured to illuminate red, green or translucent as well.

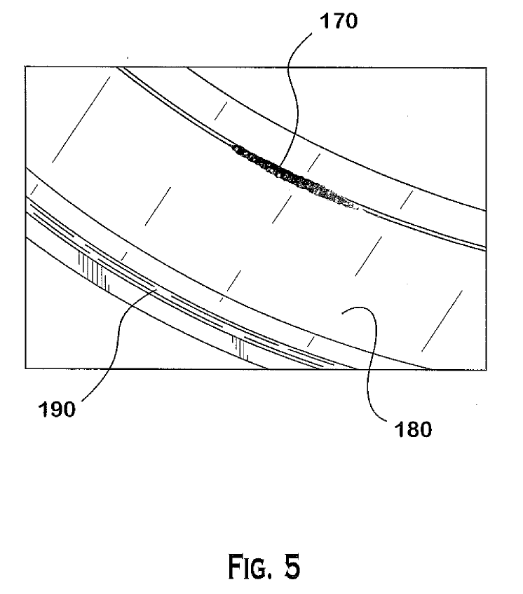

The warning device further provides at least one sensor 60 that senses at least one of a velocity, an enveloped acceleration and a temperature value of the bearing. Here, the at least one sensor 60 is mounted to a Printed Circuit Board 100 (PCB) (see FIG. 4), which is in tern potted inside the body 20 and base portion 40. Consequently, the health status of the bearing is determined by input and feedback from one of the at least one sensors 60.

When a sensor senses a change in velocity or acceleration or temperature it sets off an alarm. In an alternate embodiment, the at least one sensor 60 may provide two temperature sensors 60 and an enveloped acceleration sensor (accelerometer) 115 for providing feedback. Velocity is calculated via the accelerometer 115. A range in velocity of 10-1000 Megahertz is within a normal sensing range. A range in enveloped acceleration of 900-3600 rpm and 1-4 G's is also within the sensors 115 range. The PCB as shown in FIG. 3 may include a band pass filter 200 to filter the signal and to eliminate low frequency structural machinery vibrations signals developed in the operating environment. The PCB may further include a demodulator (250) to demodulate and enhance the frequency content at a bearing defect frequency. Consequently, the band pass filter and demodulator act to improve the frequency response of the at least one enveloped acceleration sensor 115.

FIG. 4 shows the device having multiple temperature sensors 60. The warning device has at least one thermally conductive circuit board trace 110 that is integrally disposed within the mounting pad 90. The trace 110 is designed to conduct heat from the mounting pad 90 to one of the at least one sensors 60. This is one way the device obtains temperature feedback from a sensor.

Referring now to all the Figures, the warning device 10 also includes a base portion 40 that is connected to the body 20. The base portion 40 provides a mounting pad 90 that is integral to the base portion 40. The base portion 40 is used to mount the warning device 10 to the piece of rotating industrial machinery 400. The mounting pad 90 of the present invention has a generally flat surface 140 for mounting to the machinery 400. The mounting pad (90) is hexagonal in shape and has at least two flat surfaces (130) for tightening the warning device with a tool (not shown).

The mounting pad 90 also has a threaded through hole 150 that allows a bolt (not shown) to be threaded into. Typically, the bolt runs up through a clearance hole drilled in the machinery 400 and into the threaded through hole 150, thus securing the device 10. It should be noted that there are many other potential configurations for mounting the warning device that can be contemplated by one skilled in the art. For example, the warning device could be fixedly epoxied to the rotating machinery.

The warning device 10 further includes a power source 50 for powering the device. Here, a battery 50 is utilized as the power source for powering the device 10. The battery can be a lithium battery rated for long life. Lithium batteries are disposable (primary) batteries that have lithium metal or lithium compounds as an anode. The battery is usually sealed in epoxy. As such, battery replacement is not possible. The battery (50) provides power to the device 10 for at least 3 years of normal operation. This is conditional on the device seeing only one alarm detection. Battery life decreases proportionally with the number of alarm detections. Consequently, one can expect two years of life with two alarm detections and one year of life after three alarm detections. The warning device must be manually reset after it detects an alarm condition. Therefore, if battery life permits, the warning device can be reset up to three times before replacement is required. In an alternate embodiment a solar powered source could be utilized.

The warning device 10 is synchronized to a magnetic coded key (80). One of the at least one tri-color LED' s blinks red for 10 seconds after the magnetic key is read. When the magnetic coded key 80 is applied next to the device 10 the device becomes activated. After the magnetic key is applied 80, the device 10 initiates a self check mode to verify its proper function. In operation, one of the at least one tri-color LED's 70 illuminates green when the device 10 passes its self check mode. Alternately, one of the at least one LED's 70 illuminates amber when the device fails its self check mode.

The device 10 is programmed to wake up a predetermined number of times over a 24 hour period in order to check if the industrial machine is in operation. Normally, the device wakes up 8 times per day, but this can be changed to meet a customers requirements. After waking up, at least one sensor evaluation of at least one of the velocity and enveloped acceleration and current temperature level of the industrial rotating machine is initiated. When the machine evaluation meets a minimum threshold, the device goes into an alarm mode. Further, one of the at least one tri-color light emitting diodes illuminates red after the alarm mode is verified.

Alternately, when the machine evaluation does not meet a minimum threshold after waking up and the sensor evaluation is initiated, the device goes back into a sleep mode to conserve power. The device wakes up a more frequent predetermined number of times after an alarm condition is verified. As such, one of the at least one tri-color LED blinks red for one week after an alarm condition is verified. Here, the at least one LED blinks at a constant rate and/or intensity during this period. As such, the battery life will be weakened and the overall longevity of the device reduced.

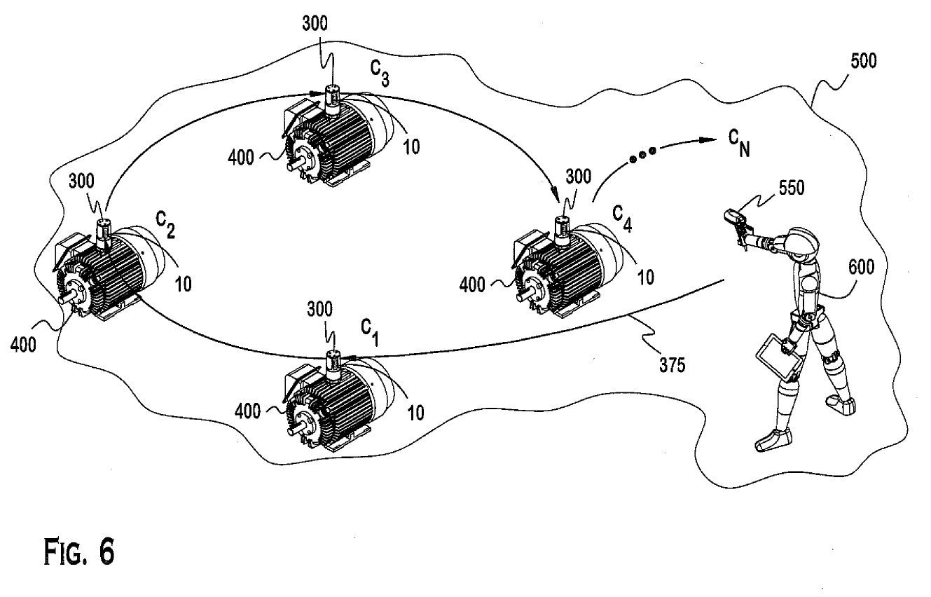

A stage 3 bearing defect is illustrated in FIG. 5. The warning device of the present invention can detect a stage 3 bearing defect 150 prior to a catastrophic failure. FIG. 5 shows a bearing raceway 190 having an inner surface 180 and stage 3 sidebanding defects 170. In the third stage of failure, bearing defect frequency levels increase and their harmonics appear on the spectrum. As wear progresses, sidebanding increases around the defect frequencies and can be seen more clearly as raised levels and harmonics in the mounted resonance area.

FIG. 6 illustrates an operator 600 pointing an inspection device 550 at a bar code disposed 300 that is disposed on the warning device in the operating environment 500. The inspection device 550 having a bar code reader that is able to scan the bar code 300 at a series check points C₁, C₂, C₃ and C₄. The check points C₁-C₄ may further provide of a plurality of check points Cₙ on a predetermined route 375 and the bar code 300 is one of a plurality of bar codes 300 on a plurality of warning devices 10 to be inspected. By making the operator conduct the inspection and record the status of each device, an operator driven reliability that proves the plurality of warning devices have been checked by the operator is generated.

In the embodiment of FIG. 7, the operator 600 is shown visually inspecting the blinking LED's 70 of warning device 10 to determine an alarm condition. Here, rather than indicating an alarm at a constant rate and/or intensity, the rate and/or intensity can change over time.

When an alarm condition has been recorded for an asset or machine the goal is to alert the operator as soon as possible. For this reason, the initial rate and/or intensity is maximized to provide greatest indicator visibility. That is, the initial rate and intensity at which the at least one LED blinks and illuminates after an alarm event is most rapid and brightest. As time passes, it is likely that the operator has observed the alarm indicator and has communicated the condition to others. However, it is also possible that the operator has not seen the alarm, so the indication will continue at a reduced rate and/or intensity in order to save power. The decrease in rate can also indicate to the operator that some time has passed since the alarm was first indicated.

This method of alarm indication maximizes visibility when an alarm is first indicated and then conserves power as time passes. In addition, as time passes the alarm indication rate decreases, allowing the operator to roughly determine how many days prior the alarm was first indicated. However, the user may have a difficult time turning a pause between blinks into an accurate estimate of how long ago the alarm was asserted by the device. Also, the long pauses near the end of the alarm indication period (typically 1 week) make it harder to see the alarm indication as the operator walks by.

However if the operator waits and stands close, the operator will see the proper indication. Consequently, the pause between LED alarm blink messages increases with time. This increase in pause time saves battery life but still provides maximum early visibility of the alarm indicator LED's. In this way, the warning device is programmed to adapt to the length of time passed from the initial alarm event and provide a deliberate, controlled reduction in the blink rate until being reset.

Since many modifications, variations, and changes in detail can be made to the five described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. A warning device for monitoring alarm status of a vibration level a piece of rotating machinery, the warning device comprising:
a body portion;
a top portion;
a base portion;
a power source for powering the device throughout a life of operation;
a control unit for controlling the operation of the warning device;
at least one colored light indicator for displaying the alarm status of the monitored vibration level; and wherein
the at least one colored light indicator being energized to blink after an initial alarm indication; and wherein
the at least one colored light indicator being controlled to blink at a relatively quick initial rate and/or intensity that maximizes indicator visibility; and wherein
the at least one colored light indicator being controlled to blink at a relatively slower decreasing rate as time passes from the initial indication event; and wherein
power source life of operation is extended by virtue of the relatively decreasing blink rate from initial alarm indication over time.

2. The warning device of claim 1, wherein the power source is a lithium battery rated for long life.

3. The warning device of claim 2, wherein the lithium battery is sealed in epoxy and is not replaceable.

4. The warning device of claim 1, wherein the power source life of operation decreases proportionally with the number of alarm detections.

5. The warning device of claim 1, wherein the power source supports operation of the warning device for three years of life after one alarm detection.

6. The warning device of claim 1, wherein the power source supports operation of the warning device for two years of life after two alarm detections.

7. The warning device of claim 1, wherein the power source supports operation of the warning device for one year of life after three alarm detections.

8. The warning device of claim 1, wherein the warning device is manually reset after an alarm condition is detected.

9. The warning device of claim 1, wherein the warning device can be reset up to three times before replacement is required.

10. The warning device of claim 1, wherein the at least one colored light indicator further comprises a tri-color LED.

11. The warning device of claim 1, wherein the control unit further comprises a circuit board that works in conjunction with at least one sensor to monitor vibration.

12. The warning device of claim 1, wherein the vibration level of a bearing is being monitored.

13. The warning device of claim 1, wherein the vibration level of a gearbox is being monitored.

14. A method of indicating an alarm status of a warning device that monitors a life of a bearing, the bearing and warning device disposed proximate to each other on a piece of rotating industrial machinery, the method of indicating the alarm status comprising the steps of:
providing the warning device having;
a control unit,
at least one colored light indicator, and
a power source; and
controlling the operation of the warning device with the control unit,
displaying the alarm status with the at least one light indicator,
powering the device throughout a life of operation with the power source;
indicating an initial alarm indication with the at least one colored light indicator, and controlling the at least one colored light indicator with the control unit to blink at a relatively quick initial rate and/or intensity that maximizes indicator visibility at initial indication;
controlling the at least one colored light indicator with the control unit to blink at a relatively slower decreasing rate as time passes from the initial indication; and wherein
extending power source life of operation by virtue of the relatively decreasing blink rate from initial indication over time is achieved.
